(19) United States
(12) Patent Application Publication
(10) Pub. No.: US 2020/0192610 A1
(43) Pub. Date: Jun. 18, 2020

(54) COMPUTER-READABLE STORAGE MEDIUM STORING A PROGRAM AND INPUT FORMAT SETTING METHOD

(71) Applicant: KONICA MINOLTA, INC., Tokyo (JP)

(72) Inventor: Takashi Ajioka, Tokyo (JP)

(73) Assignee: KONICA MINOLTA, INC., Tokyo (JP)

(21) Appl. No.: 16/707,065

(22) Filed: Dec. 9, 2019

(30) Foreign Application Priority Data
Dec. 12, 2018 (JP) 2018-232803

(51) Int. Cl. G06F 3/12; H04N 1/00

(52) U.S. Cl. CPC G06F 3/1206; H04N 1/00708; G06F 3/1253

(57) ABSTRACT

A non-transitory computer-readable storage medium storing a program causing a computer to perform additional setting of a new input item on an input format based on information regarding a supplemented portion supplemented on the input format in which an entry is made in an input field of a predetermined input item.

### BACKGROUND

### Technological Field

The present invention relates to a computer-readable storage medium storing a program and an input format setting method.

### Description of the Related Art

An input format (input form) is widely used to receive input on an input field for input items determined in advance in order to obtain necessary information. If information is input and described according to the predetermined input format, the person performing the input can efficiently input the information. The user who uses the information can obtain the information for the desired items efficiently and is able to use the information.

Examples of such input formats include an input format in which positions of the input items and a layout of the range of input are determined from the beginning, and the above is output in the position as displayed or input. In such case, even if the purpose is the same, depending on the specific person making the input who repeatedly uses the input format and the situation of the use of the input format, a uniform format may worsen the efficiency. For example, problems such as the item which needs to be used frequently may be positioned in an inconvenient position or the range may be too small.

For example, there is a technique in which, if a setting input format which receives various settings for image forming is displayed on a display screen of an image forming apparatus, the priority is suitably set for the setting items based on the frequency that the various setting items are used by the user or the layout is suitably adjusted (customized) by dividing into groups. Such technique enhances the convenience for the user (JP 2014-213459, JP 2018-85007).

However, the conventional customizing of the input format is merely to change the order of priority or the position when displaying the items in the preset menu. Therefore, there is a problem that the input format cannot be changed flexibly in response to contents which were not expected at the beginning being input or the amount of the input becoming larger than expected. Consequently, the convenience for the user cannot be enhanced.

### SUMMARY

An object of the present invention is to provide a computer-readable storage medium storing a program and an input format setting method in order to enhance convenience of input for the user more flexibly.

To achieve at least one of the abovementioned objects, according to an aspect of the present invention, a non-transitory computer-readable storage medium reflecting one aspect of the present invention stores a program causing a computer to perform additional setting of a new input item on an input format based on information regarding a supplemented portion supplemented on the input format in which an entry is made in an input field of a predetermined input item.

According to another aspect of the present invention, an input format setting method includes performing additional setting of a new input item on an input format based on information regarding a supplemented portion supplemented on the input format in which an entry is made in an input field of a predetermined input item.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a block diagram showing a functional configuration of a processing apparatus;

FIG. 2 is a diagram showing an example of an input format;

FIG. 3 is a diagram showing an example of a slip after forwarding;

FIG. 4A and FIG. 4B are diagrams describing a comparison process of the slips before and after forwarding;

FIG. 5 is a diagram showing an example of additional setting of the input format;

FIG. 6 is a flowchart showing a control process of an input format setting process executed in a processing apparatus;

FIG. 7 is a flowchart showing a control process of a modification of the input format setting process; and

FIG. 8 is a flowchart showing a control process of an input reception process when the input format is dynamically changed.

### DETAILED DESCRIPTION OF EMBODIMENTS

Hereinafter, one or more embodiments of the present invention will be described with reference to the drawings. However, the scope of the invention is not limited to the disclosed embodiments.

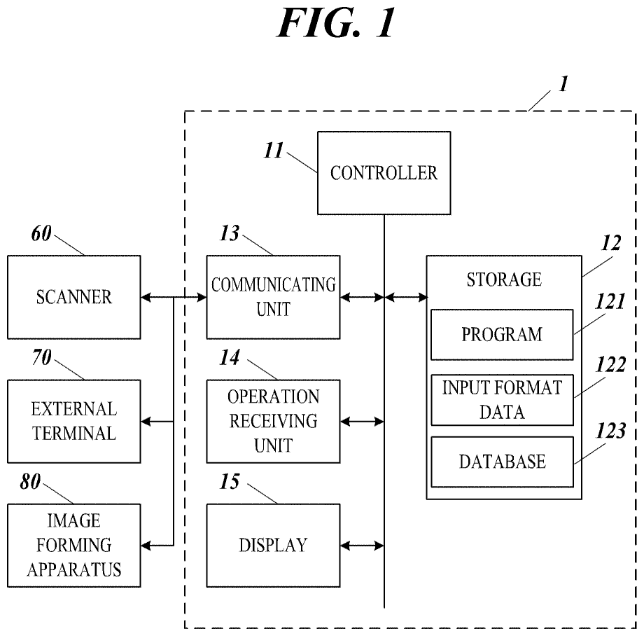

FIG. 1 is a block diagram showing a functional configuration of a processing apparatus 1 which performs a process using an input format setting method according to the present embodiment.

The processing apparatus 1 may be a typical computer (Personal Computer). The processing apparatus 1 includes, a controller 11 (hardware processor), a storage 12, a communicating unit 13, an operation receiving unit 14, and a display 15.

For example, the controller 11 includes a CPU (Central Processing Unit) and a RAM (Random Access Memory). The CPU performs the calculating process based on the data temporarily stored in the RAM, and with this, the controller 11 centrally controls various operations performed by the processing apparatus 1.

The storage 12 includes an auxiliary storage such as a nonvolatile memory or a HDD (Hard Disk Drive). The storage 12 stores setting data and programs 121. The setting data includes input format data 122 set at present. The program 121 includes a generation program of the input format, an input reception program based on the set input format data 122, and an input format setting processing program based on the input data. The storage 12 includes a database 123. The database 123 stores past output data created using the input format (here, slip data), final data after forwarding the output slip, and the list of the words in a target field (field according to purpose) of the input format.

The communicating unit 13 controls the data communication with external devices according to a predetermined communication standard. For example, data communication includes communication by LAN (Local Area Network) and the predetermined communication standard includes TCP/IP (Transmission Control Protocol/Internet Protocol). Here, the communicating unit 13 is connected to a scanner 60, an external terminal 70, and an image forming apparatus 80 (printer) through a hub or a router.

The scanner 60 optically reads a surface of a set medium and generates image data. The external terminal 70 is another computer. For example, the external terminal 70 accesses to the processing apparatus 1 by remote and executes the input reception program. Alternatively, under the input reception program, the external terminal 70 receives created documents, performs processes such as to include supplemental comments and to approve the documents, and transmits the documents to the next person in charge. The image forming apparatus 80 forms (prints) on the recording medium the image according to the obtained image data. The processing apparatus 1 can be connected to a multifunction machine including both the reading function of the scanner 60 and the image forming function of the image forming apparatus 80.

The operating receiver 14 receives external input such as input from the user, and outputs to the controller 11 a control signal in response to the received contents. For example, the operation receiving unit 14 includes a mouse, a keyboard, and a touch sensor used as a touch panel. The operation receiving unit 14 includes other press button switches and/or rotating switches.

The display 15 displays various statuses and menus according to an instruction from the controller 11. For example, the display 15 includes a display screen such as a liquid crystal display (LCD) or an organic EL (Electro-Luminescent) display. When the operation receiving unit 14 includes a touch panel, the display screen is provided overlapped with the touch sensor. Alternatively, the display 15 may include a LED lamp and/or an indicator.

Next, the input format received by the input reception program according to the present embodiment is described.

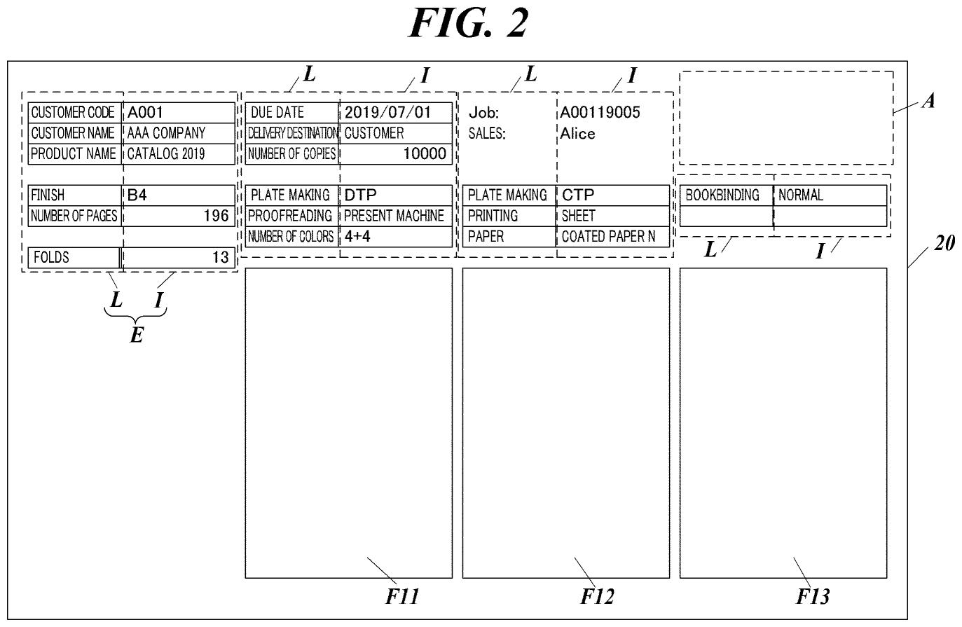

FIG. 2 is a diagram showing an example of a set input format 20.

The input format 20 includes an example of a slip used in a printing company. According to the input format 20, a plurality of input items E are displayed in positions set in advance. In the input item E, a label space L (title) and an input field I are arranged aligned. A candidate (option) of an input value (not limited to numeric values and refers to registered input contents in general) may be set in advance in some or all of the input fields I, and the input in the input field I can be performed by selecting from a pulldown menu. Alternatively, the person creating the slip can input text in the input field I based on the label. Alternatively, there may be input items in which radio buttons are provided and a selection can be made from the radio buttons, or a date (year/month/day) can be selected from a date picker. There are three free comment spaces F11 to F13 positioned at the bottom of the area of the input format 20. The blank space A is a predetermined space used for signatures by those who are concerned, for example, the person in charge, a supervisor, and an inspector.

Such input format 20 is generated by executing a generation program in the processing apparatus 1 and positioning the input format 20 in a slip area with a size set automatically or manually by the user based on input items determined in response to input operation by the user (generating unit, generating step). Here, generation is not limited to generating the entire input format 20 from scratch, and includes setting a new input format 20 by editing the input format 20 set in advance.

The person who makes the slip as the user starts the input reception program to display the input format 20 on the display 15 or the external terminal 70. The user performs an operation to input the necessary items in the input fields I of the display screen through the operation receiving unit 14. The user may instruct the apparatus to transmit the input to the image forming apparatus 80 to form the image of the slip and to register the input values (if there are no input values at all, slip data with no input can be registered). The slip data (entered data) including the registered contents is stored as is. Even if the image is formed, the obtained slip data (entered data) is stored separately in a database 123 of the storage 12. This includes a case in which a recording medium in which a slip is formed is read by the scanner 60 again and held as slip data. Items such as the base portion of the input format such as the title, grid line and label and the standard input values in the input field I (as described above, there may be no input values at all) are contents not included in the later-described supplemented portion in the input format. If the person creating the slip makes comments in the free comment spaces F11 to F13, the comments are not included in the supplemented portion. However, the comments made in the free comment spaces F11 to F13 by the person who makes the slip can be included in the supplemented portion as described below.

The formed slip (recording medium) or the electronic data with the input value registered is forwarded in order to those who are concerned, for example, the person in charge, supervisor, and inspector. If the electronic data is forwarded, those who received the data start the input reception program as the user. With this, the person who received the data is able to view the data with the input fields I already input. In this case, the data may be displayed so that the data input and registered by the person who made the slip cannot be erased or changed.

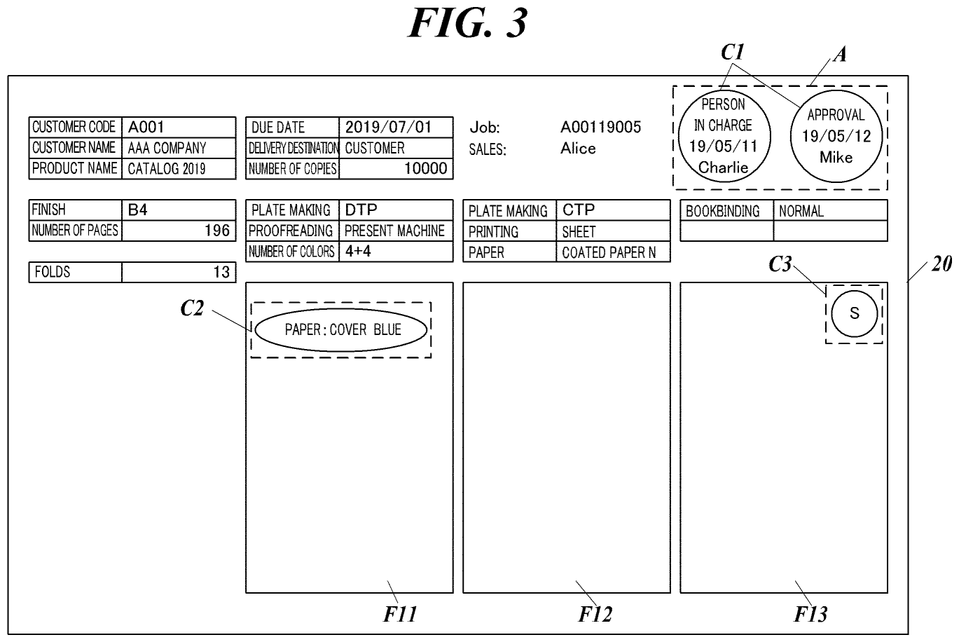

FIG. 3 is a diagram showing an example of a slip after forwarding. The person who received the slip inputs a signature C1 in the blank space A at the top right of the forwarded slip. Here, comments C2 and C3 are supplemented in the free comment spaces F11 and F13. Such input and supplements (the above is collectively referred to as the supplemented portion in the input format but as described below, the input in the blank space A can be omitted from the supplemented portion) can be added as electronic data or may be written by hand in the recording medium in which the image is formed. The final slip data (supplemented data) including the supplemented portion is stored in the database 123 of the storage 12. If the supplement is written by hand, the administrator can use the scanner 60 to read the surface of the filled slip on the recording medium at any timing later on or at a predetermined timing set in advance, and the forwarded image data can be obtained as final slip data.

In the processing apparatus 1, the input format setting processing program is started to perform a comparison process of the contents described in the slip before and after forwarding, and the contents supplemented during the forwarding is extracted from the slip in which forwarding ended. In the input format setting processing program, if the extracted contents satisfy a predetermined standard, additional setting can be made in the input items according to the supplemented contents.

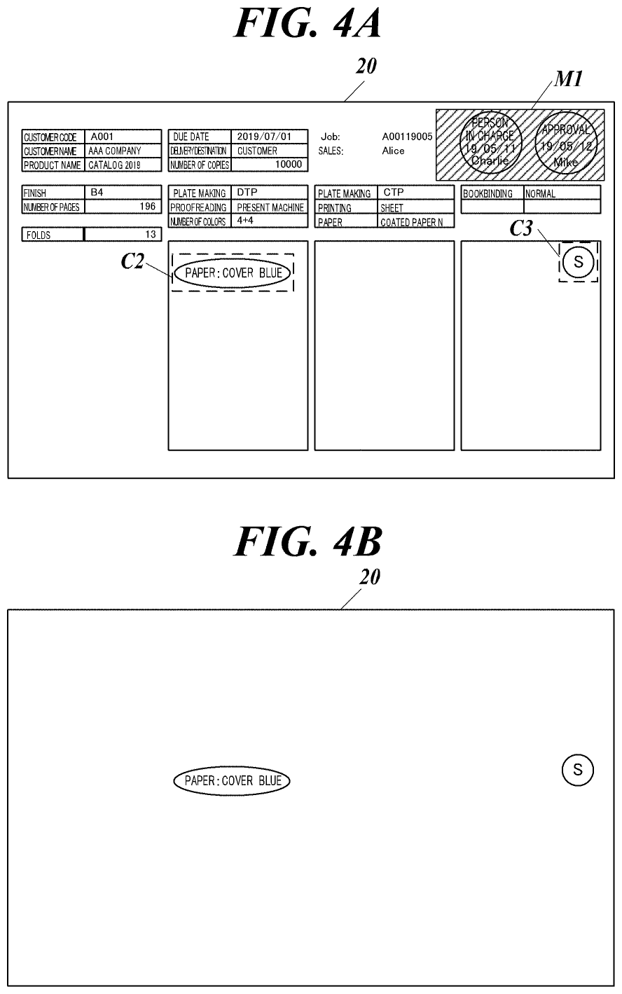

FIG. 4A and FIG. 4B are diagrams which describe a comparison process which compare slips before and after forwarding.

As shown in FIG. 4A, it is possible to set the comparison process so that the supplemented portion in the blank space A (see FIG. 2, FIG. 3) in which a fixed input is always made is not detected, that is, the input contents (part of the supplemented portion) may be excluded from the extracted target in the supplemented portion when the comparison process is performed. Here, a mask M (detection excluded portion) is set in a range corresponding to the blank space A, and the input (supplemented portion) in the area covered by the mask M is not extracted (first exclusion setting unit).

As shown in FIG. 4B, if the data in the slip created by the person who created the slip is compared with the data of the slip after forwarding in the range other than the area with the mask M, comments C2 and C3 which are input and supplemented during the forwarding are extracted. The input position of these comments C2 and C3 in the slip are specified. If the supplement is made by hand (including supplements by editing image data using drawing software or painting software), supplements may be made (there may be a supplemented portion) outside the input field I. The processing apparatus 1 performs a statistical process regarding the display position of the extracted supplemented contents for the output slips using the same input format. If the supplements are extracted at a frequency or percentage showing the reference, the extracted contents are specified, and additional setting is made in the input format with the input items corresponding to the contents as the new input items. Additional setting includes, newly added input items and additional options of input contents in the existing input items (that is, the number of input items do not always increase).

If there are supplements in the free comment spaces F11 to F13, a portion of the range of the free comment spaces F11 to F13 may be divided according to the position of the supplement and new input items can be generated in the obtained range (added position). Alternatively, if it is specified to be corresponded to an input item (input field and/or label) with an arrow or leader line and if a word which is the same as an existing label frequently appears in the supplemented contents, for example, there may be a change to add the character string appearing frequently in the supplemented contents as an option in the pulldown menu of the input field corresponding to the existing label, or a new input item may be provided in the position adjacent to the existing label. If a portion of the supplemented contents is redundant and the remaining portion is different, the contents may be grouped so that the portion of the supplemented contents is corresponded to the label and the remaining different portion is used as elements (contents) of the options. If the supplemented contents are only shapes, and labeling by characters is difficult, only a dedicated input field may be made without attaching a label. In comment C2, the word “paper” is included and it is possible to assume that this is related to the existing “paper” setting. In the region in which the above-described mask M is applied (setting excluded portion), it is possible to set that a new input item is not set based on the supplemented portion extracted from other regions (second exclusion setting unit).

In specifying the contents, if character data is included in the electronic data, the characters can be used as is. If bitmap image data obtained by reading the image with the scanner 60 or electronic data in which the supplemented content is the bitmap image data is included, for example, by using character recognition software for OCR (Optical Character Recognition), well-known various processes to discriminate characters and shapes from outlines in the supplemented contents of the image data can be performed to specify contents such as the character string and the shapes (image determining unit).

The wording and the symbol in the specified supplemented contents do not have to be used as is. As for terms used in the industry and terms which are accepted only within a certain group, a database can be made in advance to show the corresponding relation between the certain term and the typical term and this can be registered in the database 123. Such terms can be changed to typical terms. Similarly, abbreviations can be changed to its proper name or known name. For example, if the character S surrounded by a circle in the comment C3 shown in FIG. 3 and FIG. 4A is a typical abbreviation for “Secret” in a related industry using the slip, the letter “S” can be replaced with the description “Specified as Secret” based on the database corresponding “S” with “Secret” (Specified as Secret) and the process later on may be performed. If it is determined whether the above is added to the pulldown menu, in addition to specifying the supplemented contents, a judgement can be made in advance to determine whether the supplemented contents can be selected parallel with relation to the existing options.

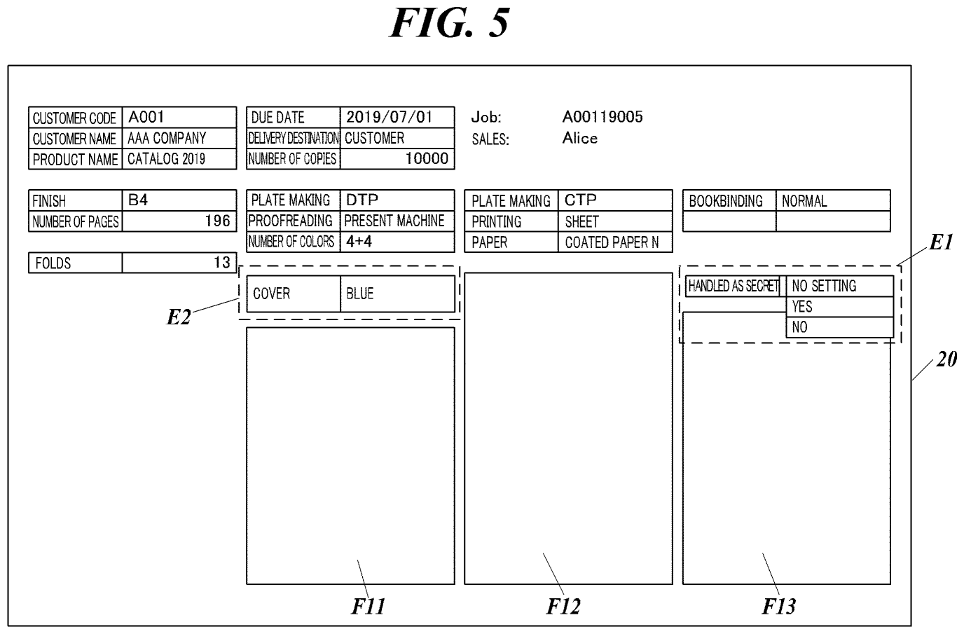

FIG. 5 is a diagram showing an example of an additional setting of the input format.

If the frequency that the comment C3 is supplemented in the free comment space is higher than the reference, for example, the right edge free comment space F13 may be made smaller, and the input item E1 in which the label name is set to “Handled as Secret” according to the above supplemented contents is added. Here, it is possible to select “no setting”, “yes” or “no” as options from the pulldown menu. If the comment C2 regarding the setting of the paper used as the cover, that is, the setting of a paper color or a paper different from the paper selected in the normal portion is supplemented at a high frequency in the free comment space, for example, the left edge free comment space F11 may be made smaller, and the input item E2 with the label name “cover” is added. The options are not provided in the input field, and the size is set according to the supplemented portion (here, only characters), here, a size with two lines is set so that the paper color and the paper type can be described using one line each. The width of the input field is determined by the width corresponding to the label with “paper” among the existing input items (that is, size with the number of characters in the similar character string).

According to the input format setting process program of the present embodiment, the change to the input format with the additional setting is not performed automatically, and approval from the person in charge (person responsible) is requested regarding the changed contents in the additional setting. If the approval is obtained from the person responsible, the input format used when the input is received from then on is changed (update setting) and if the change is denied by the person in charge, the input format is not changed and the additional setting is destroyed. Here, once the slip is created and the forwarding is not finished, even if the display is performed by those who may be concerned (person in charge, supervisor, inspector) during the forwarding, the input format is not changed.

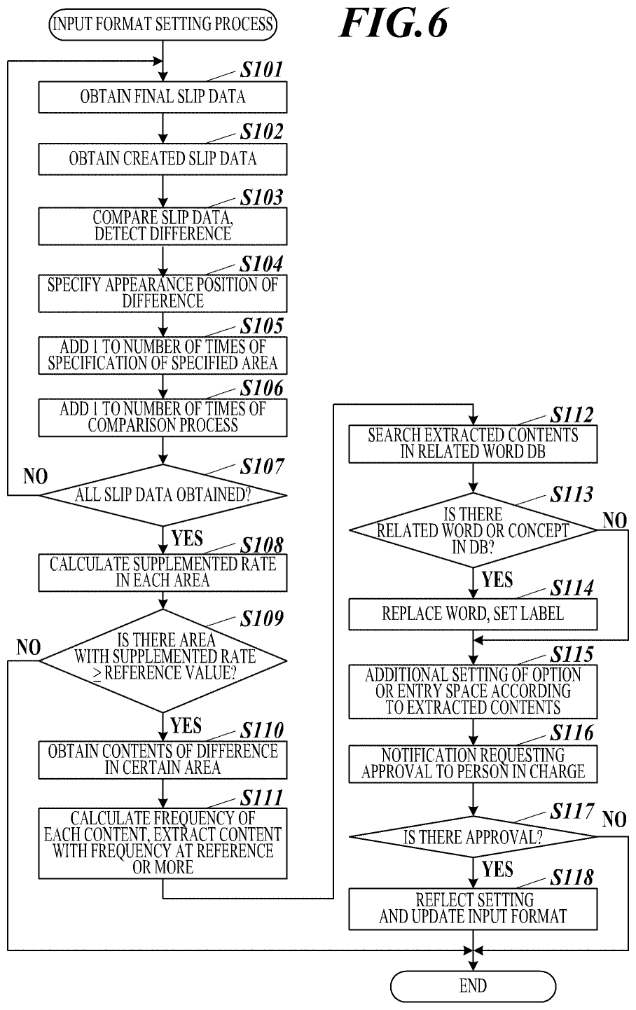

FIG. 6 is a flowchart showing a control process by the controller 11 for the input format setting process executed by the processing apparatus 1.

When the input format setting process starts, the controller 11 obtains the final slip data after forwarding with the new input included in the data (step S101). The controller 11 obtains the slip data at the time the slip was created (before forwarding) corresponding to the final slip data (step S102). The controller 11 compares the slip data before and after forwarding (that is, before and after the supplement) while applying the above-described mask M. The controller 11 which detects the difference (step S103; detector) specifies the position where the detected difference appears (step S104; position specifier). The appearing position is specified in a unit of area (block). For example, the area can be set by dividing the display range (input area) displaying the input format 20 finely in a mesh state (for example, a size of about one letter in a font typically used to display the slip).

The controller 11 adds “1” to the number of times that the area is specified for the specified area (appearance frequency) (step S105). The controller 11 adds “1” to the number of times that the comparison process is performed (step S106).

The controller 11 determines whether all of the data for the final slip in which new input is included is obtained (step S107). If it is determined that all of the data for the final slip is not obtained yet (step S107, “NO”), the process of the controller 11 returns to step S101.

If it is determined that all of the data for the final slip is obtained (step S107, “YES”), the controller 11 calculates the occurrence rate of the difference in each area (supplement rate) from the number of times that the supplement is specified in each area and the number of times that the comparison process is performed which were both counted (step S108). Such number of times of specification and the number of times of performing the comparison process can be a value integrating the value from when the setting of the input format was changed previously.

The controller 11 determines whether there is a supplement rate calculated from each area in which the value is equal to or larger than a predetermined reference rate (step S109). If it is determined there is none (step S109, “NO”), the controller 11 ends the input format setting process. Here, as described above, the number of times of specification and the number of times of performing the comparison process can be stored.

If it is determined that there is the supplement rate for each area showing a value equal to or larger than a predetermined reference rate (step S109, “YES”), the controller 11 obtains the contents of the difference in the area with the supplement rate which is equal to or larger than the reference value (step S110). The controller 11 specifies the character string, the symbol, and the shape of the extracted portion as the difference. If there is a combination of a plurality of character strings, symbols and shapes, it is possible to consider that there are a plurality of different contents, or there is one collective content.

The controller 11 calculates the frequency of appearance for each of the contents. The controller 11 extracts the contents with the appearance frequency equal to or larger than a reference frequency (step S111). As described above, if there is an expression which is redundant in only a portion of the contents, it is assumed that there are a plurality of types of supplements regarding the same or related contents, and a total appearance frequency of the above is obtained.

The controller 11 refers to the database 123 and performs a search on the extracted contents (step S112). As a result of the search, the controller 11 determines whether the extracted contents itself, a word related to the extracted contents or a concept including the extracted contents is found in the database 123 (step S113). If it is determined not to be found (step S113, “NO”), the process by the controller 11 proceeds to step S115. If it is determined to be found (step S113, “YES”), the controller 11 replaces the words to more suitable words according to the extracted contents and the search result, and sets the label if a new entry space is added (step S114). Then, the process by the controller 11 proceeds to step S115.

If the process proceeds from steps S113 and S114 to step S115, the controller 11 adds an option corresponding to the extracted contents in the pulldown menu of the respective input field and adds a new input item (step S115). The setting data of such changes is stored separate from the setting data of the present input format.

The controller 11 transmits a notification requesting approval of the change in the setting from the person in charge (person responsible) of the setting of the input format (step S116). The controller 11 waits for the reply of the approval. If there is a reply, the controller 11 determines whether there is an approval (step S117). If it is determined there is an approval (step S117, “YES”), the controller 11 reflects the setting of the new input format including the additional setting, and updates (update setting) the input format (input form) used when the input is received (step S118). Then, the controller 11 ends the input format setting process. If it is determined that there is no approval (denied) (step S117, “NO”), the controller 11 does not reflect the newly set input format and destroys the input format. With this, the input format setting process ends.

The process in steps S105 to S115 includes an additional setting (additional setting step in the input format setting method) in the program regarding the input format setting method according to the present embodiment.

### Modification

The change in the input format according to the present embodiment can be performed dynamically. For example, if a specific supplemented content is supplemented with a high correlation with predetermined input contents in an existing input item, the input format can be updated and changed according to whether there is input in the predetermined input contents in the existing input item and the display can be switched between whether or not to display the input item in which the specific supplemented content can be input on the display screen of the input format.

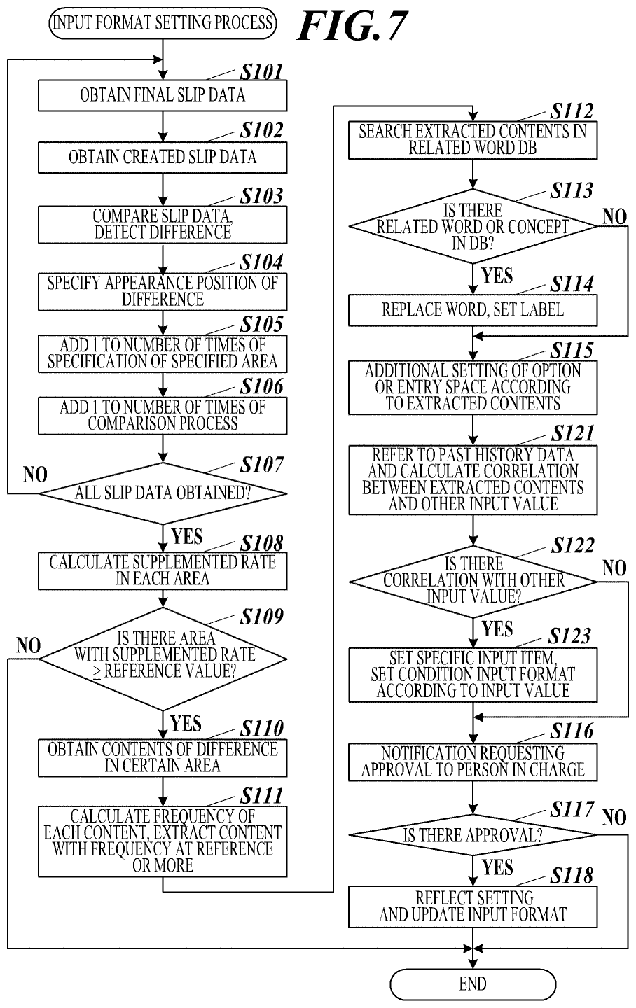

FIG. 7 is a flowchart showing a control process by the controller 11 which executes the input format setting process of the modification.

The process in steps S121 to S123 are added in the input format setting process of the modification. The other processes are the same. The same reference numerals are applied to the same processing contents and the detailed description is omitted.

After the process in step S115, the controller 11 refers to the database 123 and uses the input history (final slip data) using the present input format to calculate the correlation between whether there is a supplement in the extracted contents regarding the additional setting and the input value in the input field of the existing input items (step S121; correlation calculating unit). The controller 11 determines whether the correlation (for example, correlation coefficient) with any of the input values is in a size equal to or larger than a reference (step S122).

If it is determined that the correlation coefficient with any of the input values is in a size equal to or larger than the reference (step S122, “YES”), the controller 11 sets the input item regarding the input value as a specific input item. The controller 11 performs a setting to be able to dynamically switch between the newly set input format and the conventional input format according to the input value in the specific input item (step S123). In this case, the controller 11 may select whether the newly set input format or the conventional input format is to be the initially set input format depending on the percentage of the input in the input value determined to have correlation. Alternatively, the initial setting can be uniformly determined to either one of the above. Then, the process by the controller 11 proceeds to step S116.

If it is determined that the correlation coefficient with any of the input values is not in a size equal to or larger than the reference (step S122, “NO”), the process by the controller 11 proceeds to step S116.

If it is set to also use the conventional input format in the process in step S123, the controller 11 does not erase the conventional input format in the process in step S118. Moreover, the controller 11 determines one of the input formats as the input format used in the initial setting and the other input format as the input format used when switched under certain conditions, and stores the above.

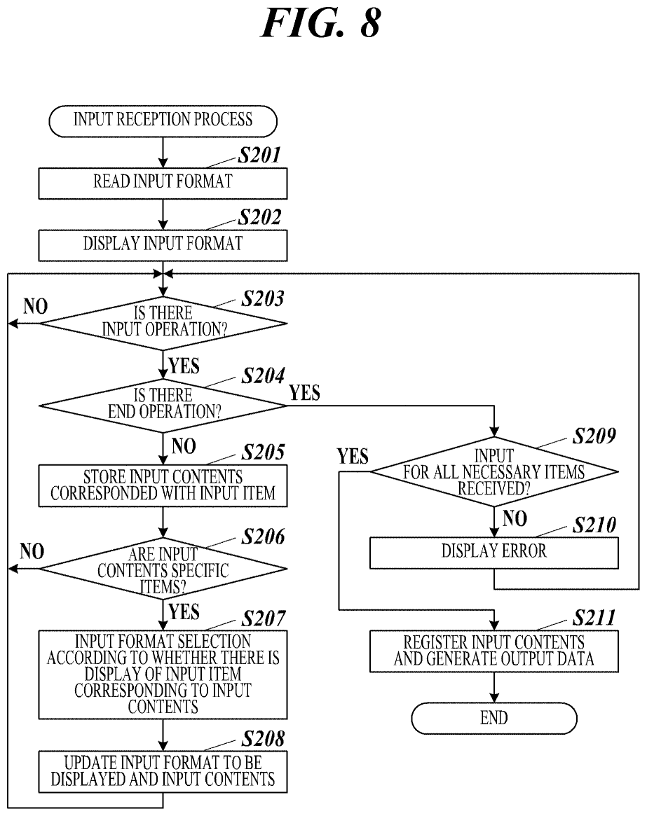

FIG. 8 is a flowchart showing a control process by the controller 11 executing the input reception process when the input format is dynamically changed.

If the input reception process starts, the controller 11 reads the input format which is initially set (step S201). The controller 11 displays the input screen according to the read input format (step S202).

The controller determines whether the input operation is received (step S203). If it is determined that the input operation is not received (step S203, “NO”), the controller 11 repeats the process in step S203.

If it is determined that the input operation is received (step S203, “YES”), the controller 11 determines whether the input contents is the operation to end the input (step S204). If it is determined that it is not operation to end (step S204; “NO”), the controller 11 stores the input contents corresponded with the input items (step S205). Such input contents include not only the input operation to add descriptions in the input field and also includes a process to erase the input contents.

The controller 11 determines whether the input contents are a specific item (step S206). Here, the specific item is an item in which the input format is changed according to the input contents, as described above. If it is determined that it is not the specific contents (step S206, “NO”), the process by the controller 11 returns to step S203.

If it is determined that it is the specific item (step S206, “YES”), the controller 11 determines whether to display to the input item in which the display can be switched corresponding to the input contents of the specific item and selects the input format according to the determination (step S207). The controller 11 updates the display to also display the contents which is received as input on the displayed input format (step S208). If it is determined that the update of the display by the process in step S207 is not necessary (the input format is not changed), the process in step S208 can be omitted. Then, the process by the controller 11 returns to step S203.

If it is determined in the process in step S204 that the input operation is an operation to end the process (step S204, “YES”), the controller 11 determines whether input is received in all of the necessary items (step S209). If it is determined that there are necessary items in which the input is not received (step S209, “NO”), the controller 11 displays an error display (step S210), and returns the process to step S203.

If it is determined that there is input in all of the necessary items (step S209, “YES”), the controller 11 stores and registers the input contents in the storage 12 and generates output data (step S211). Then, the controller 11 ends the input reception process. If there are no necessary items, the process in steps S209 and S210 can be omitted. In this case, the controller 11 performs the registration process even if there are no input contents and ends the input reception process.

As described above, the program 121 (input format setting process program) regarding the input format setting method according to the present embodiment is stored in the storage 12. The program 121 controls the processing apparatus 1 which is a computer to perform the function of the additional setting unit which adds setting to the input item E in the input format 20 based on the information regarding the supplemented portion supplemented in the input format in which the information is filled in the input field I of the input item E determined in advance (title of input format, outline and label, and comments C2 and C3 which are input other than typical input in the input field I) (processes in steps S105 to S115).

As described above, based on the supplemented portion other than the typical description, new input items can be added or options for input values in the input field can be newly added. Therefore, in addition to customizing whether to display input items set in advance or changing the display position of such input items, the convenience of input can be enhanced by handling the input tendency of the user more flexibly.

The program 121 controls the processing apparatus 1 to function as the detector (process in step S103) which compares the data before and after the supplemented portion is supplemented (that is, the slip data when the slip is created and the final slip data) and detects the difference. That is, by obtaining the difference between the original entered data (including no entry) at the time the data is created using the input format 20 and the data with supplements after forwarding, it is possible to change the input format to a more convenient format for not only the person who created the original data but also all of those who use the slip created using the input format 20.

The program 121 controls the processing apparatus 1 to function as a position specifier which specifies an appearance position of a difference detected by a detector, obtains the appearance frequency of the difference in each block (a plurality of blocks as a result of dividing the input area determined by the input format), and determines whether to perform additional setting based on the appearance frequency (that is, even if the appearance frequency itself is used, the supplement percentage obtained using the appearance frequency can be used).

In actual use of the slip, similar comments are often entered in similar positions. Therefore, by performing the additional setting in the input items according to the frequency comments, the input item may be suitably changed. With this, the convenience of the user is enhanced.

According to the program 121, the additional setting unit determines the additional position of the input field in response to the appearance frequency.

As described above, by performing additional setting regarding new input items in positions where comments are supplemented frequently, it is possible to change the setting of the input format 20 to be highly convenient so that there is no burden on the user who makes the comments and the user who uses the comments.

According to the program 121, the additional setting unit adds the input field with the size according to the size of the supplemented portion. That is, in most cases, the person entering the comments can enter the comments without trouble in the input field with the size according to the supplemented comment. Moreover, the conventional input field of the input item is not compressed more than necessary.

According to the program 121, the additional setting unit determines the label of the input item including the input field added according to the contents of the supplemented portion. That is, by setting a suitable label according to the input contents, the user of the slip is able to easily understand that the newly additionally set input field is the conventional area corresponding to the supplemented comment regarding the additional setting.

According to the program 121, if the contents of the supplemented portion includes only characters, the additional setting unit determines the width of each line of the input field according to the number of characters. That is, compared to input of shapes or symbols, if the characters are input, the suitable size can be easily defined. Specifically, if the character string is input electronically, a font with substantially the same size as the conventional font input in the input field I is to be used. Therefore, the input field I is not made to a size larger than necessary or smaller than necessary, and the input and the input contents can be suitably confirmed and used.

According to the program 121, the additional setting unit determines the size of the input field according to the number of characters of the character string showing the contents of the supplemented portion. If the number of input characters is roughly determined, not only the width of the line but also the width of the input field I can be determined according to the number of characters. Therefore, those who use the slip can easily and suitably make an input or use the input contents in the changed input format 20.

According to the program 121, the additional setting includes adding the option of the input contents in the existing input field, and the additional setting unit determines the contents of the option added according to the contents of the supplemented portion. That is, the program 121 does not only simply increase the input fields but also expands the existing input items. Therefore, the input format 20 can be set more flexibly to be highly convenient for the user.

According to the program 121, the additional setting unit groups the contents of the supplemented portion based on the word list regarding the field according to the purpose of use of the input format. If a plurality of contents are corresponded to one group, the new input item including the plurality of contents as the option is additionally set.

That is, the database 123 stores a word list in advance. With this, it is possible to easily understand the relation among the supplemented contents, and the relation between the supplemented contents and the existing input item. Therefore, the supplemented contents can be grouped flexibly and suitably, and suitable setting regarding the input item can be performed.

The program 121 controls the processing apparatus 1 to function as the detector which compares the data before and after the supplemented portion is supplemented to detect the difference and the image determining unit which determines the contents of the difference detected from the image data of the supplemented data. That is, even if the supplemented contents are not contents which can be easily understood as in text data, the difference is detected from bit map image data and the contents can be specified. Therefore, even if the contents are supplemented in the slip which is output and forwarded as a paper medium, the above processes can be easily performed, and it is possible to perform a setting to change to a more suitable input format 20.

The program 121 controls the processing apparatus 1 to function as the first exclusion setting unit which sets a mask M in a range where detection of the supplemented portion is not performed in an input area determined by the input format 20. For example, detection stamps and/or signatures are supplemented contents in which it is clear in advance that the contents will be supplemented. Such supplemented contents can be excluded from the setting process regarding the change of the input format 20. Therefore, unnecessary processes can be reduced.

The program 121 controls the processing apparatus 1 to function as the second exclusion setting unit which sets a mask M in a range where detection of the additional setting is not performed in an input area determined by the input format 20. That is, the input items based on other supplemented contents are not added to the region where it is clear that the detection stamps and/or signatures will be supplemented. Therefore, unnecessary trouble such as there being no space for the detection stamps and/or the signatures does not occur.

The program 121 controls the processing apparatus 1 to function as the correlation calculator (step S121) which calculates the correlation between the contents of the added portion and the contents input to the existing input items. If the input on the input format 20 is received electronically, the additional setting unit sets the input format 20 so that the existence of the additional setting according to the supplemented portion can be switched in response to whether there is input on the supplemented portion including input contents with a correlation in a predetermined reference or more.

That is, if there is a correlation between the supplement of the position and contents as the added target and the specific input contents in the existing input item, it is possible to switch between whether or not to additionally display the input items according to the input contents with correlation. According to the above, the new input items are not increased when it is assumed that there is no supplements according to the specific input contents. Therefore, the user is not troubled with unnecessary burdens and the convenience of the user is enhanced.

The input format setting method according to the present embodiment includes an additional setting step which performs additional setting of the new input item on the input format based on the information regarding the supplemented portion supplemented on the input format in which the input field of the predetermined input item is filled.

As described above, based on the supplemented portion, a new input item can be added and an option of the input value in the input field can be newly added. Therefore, in addition to customizing whether to display a predetermined input item or to change the display position of such input item, the convenience of input can be enhanced more flexibly according to the tendency of input by the user.

The present invention is not limited to the above-described embodiment and various modifications are possible.

For example, the supplements filled in during the forwarding by those other than the person who created the slip are extracted. Alternatively, the items filled while the slip is being used by the person who created the slip can be similarly a target of additional setting regarding the input item. Further, the contents described in the free comment spaces F11 to F13 can all be determined to be supplemented contents regardless of the timing and who entered the comments. That is, in addition to after the original slip is made (including registration without entry), cautions and further contents in the free comment spaces F11 to F13 entered by the person who created the slip at the time the slip is made are also included in the supplemented portion in the input format. In this case, there is no need to compare the data of the slip at the time the slip is created with the final data slip to obtain the difference.

If there is handwritten input which is not entered inside the free comment spaces F11 to F13 and the input field I, all of such entry outside the fixed input field I on the input format can be extracted as the supplemented portion. In this case also, there is no need to compare the data at the time the slip is created with the final slip data. Alternatively, a difference may be obtained from the setting data of the input format including the outline of the input item and the label. Here, the mask M (detection exclusion portion) can be set on the entire portion inside the input field I so that the input values in the input field I are not extracted. Alternatively, considering that a portion of the supplemented portion may be repeated in the input field I, if the options are determined according to a pulldown menu for the input value in the input field I, the remainder excluding the contents matching with the option can be considered to be the supplemented portion. If there are no options, an entry in which even a portion is outside the input field I can be considered to be the supplemented portion. Also, the input contents can be decoded and grouped, and it is possible to determine whether it is the supplemented portion by whether the predetermined center position of each group is within the input field I. If the final slip data is a structure document using a tag, the determination can be made based on the type of tag and position.

According to the present embodiment, the frequency of the supplement is determined for each input area, but alternatively, the input contents can be specified regardless of the input area and the additional setting regarding the input item can be performed based on the appearance frequency of the contents.

According to the present embodiment, the difference is detected by comparing the data before and after the supplement, but information regarding updated timing can be added to the supplemented contents and the contents added at the timing different from the timing that the slip is originally created can be extracted as the supplemented portion.

According to the present embodiment, the position of the added input item (input field) can be set to be optimized with relation to the position of the existing input items regardless of the position of the supplemented portion regarding the adding.

According to the present embodiment, the size of the input field is determined according to the number of characters entered in the supplemented data. Alternatively, a determination can be performed to set a larger range if the other input contents assumed from the number of characters actually supplemented is larger than the number of characters.

According to the present embodiment, the word list is stored in the database 123 in the processing apparatus 1, but external data such as a cloud server can be referred.

According to the present embodiment, a slip output on a recording medium can be read by a scanner 60 again. Alternatively, if it is assumed that the process is performed with all of the data being electronic data, the detection process of the supplemented portion and the specifying process of the contents which are processes specific to read data can be omitted.

According to the present embodiment, the slip according to the position of the input format 20 is output. Alternatively, if it is assumed that the process is performed with all of the data being electronic data, the display position can be changed according to the size and/or the aspect ratio of the display screen. In this case also, the detection and the additional setting is performed based on the display position which is to be the reference in the processing apparatus 1.

According to the present embodiment, the program 121 is executed to perform the input format setting process as software. Alternatively, some or all of the processes can be performed in dedicated hardware.

Alternatively, some processes such as the image processing can be performed in an external processing apparatus.

According to the present embodiment, creating and forwarding the slip is described, but the present invention is not limited to the above. Other various documents and page input data can be the subject of the process. The above do not have to be forwarded. That is, entry other than typical input made by a single user or common users can be considered and the new input item can be added.

According to the above description, as the computer readable storage medium including the program 121 regarding the input format setting process to implement the embodiment, a storage 12 using a nonvolatile memory or a hard disk drive (HDD) are disclosed but the embodiments are not limited to the above. For example, a portable storage medium such as a CD-ROM, DVD disk, etc. can be applied as the computer readable storage medium. A carrier wave is also applied as the medium to provide data of the program according to the embodiments through the communication lines.

The details of the configuration, contents of processing and procedure of processing shown in the embodiments can be suitably changed without leaving the scope of the present invention.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese Patent Application No. 2018-232803, filed on Dec. 12, 2018, including description, claims, drawings and abstract is incorporated herein by reference in its entirety.

What is claimed is:

1. A non-transitory computer-readable storage medium storing a program causing a computer to perform:
additional setting of a new input item on an input format based on information regarding a supplemented portion supplemented on the input format in which an entry is made in an input field of a predetermined input item.

2. The non-transitory computer-readable storage medium according to claim 1, wherein the program causes a computer to perform comparing of data before and after the supplemented portion is supplemented and detecting a difference.

3. The non-transitory computer-readable storage medium according to claim 1, wherein,
the program causes a computer to perform specifying of a position where a difference appears in the data before and after the supplemented portion is supplemented, and
in the additional setting, a frequency of the appearance of the difference in each block generated by dividing an input area determined by the input format into a plurality of blocks is obtained and it is determined whether the additional setting is performed based on the appearance frequency.

4. The non-transitory computer-readable storage medium according to claim 3, wherein in the additional setting, an additional position in the input field is determined according to the appearance frequency.

5. The non-transitory computer-readable storage medium according to claim 1, wherein in the additional setting, an input field with a size according to a size of the supplemented portion is added.

6. The non-transitory computer-readable storage medium according to claim 1, wherein in the additional setting, a label is determined for an input item including the input field added according to contents of the supplemented portion.

7. The non-transitory computer-readable storage medium according to claim 6, wherein in the additional setting, in response to contents of the supplemented portion being only characters, a width of a line in the input field is determined according to the number of characters.

8. The non-transitory computer-readable storage medium according to claim 6, wherein in the additional setting, a size of the input field is determined according to a number of characters in a character string showing contents of the supplemented portion.

9. The non-transitory computer-readable storage medium according to claim 1, wherein,
the additional setting includes adding an option of input contents in the existing input field; and
in the additional setting, contents of the added option are determined according to the contents of the supplemented portion.

10. The non-transitory computer-readable storage medium according to claim 9, wherein, in the additional setting, contents of the supplemented portion are grouped based on a word list regarding a field according to a purpose of use of the input format, and in response to corresponding a plurality of contents to one group, a new input item including the plurality of contents as the option is additionally set.

11. The non-transitory computer-readable storage medium according to claim 5, wherein the program causes a computer to perform:
comparing of data before and after the supplemented portion is supplemented and detecting a difference; and
image determining which determines contents of the difference.

12. The non-transitory computer-readable storage medium according to claim 1, wherein the program causes a computer to perform first exclusion setting which sets a detection excluded portion in which the supplemented portion is not detected from the input area determined by the input format.

13. The non-transitory computer-readable storage medium according to claim 1, wherein the program causes a computer to perform second exclusion setting which sets a setting excluded portion in which the additional setting is not performed on the input area determined by the input format.

14. The non-transitory computer-readable storage medium according to claim 1, wherein,
the program causes a computer to perform calculating of a correlation between contents of the supplemented portion and input contents to an existing input item, and
in the additional setting, the input format is set so that whether to perform the additional setting according to the supplemented portion is switched in response to whether there is input of input contents in which there is a correlation equal to or more than a predetermined reference with relation to the supplemented portion in response to electronically receiving input on the input format.

15. An input format setting method comprising:
performing additional setting of a new input item on an input format based on information regarding a supplemented portion supplemented on the input format in which an entry is made in an input field of a predetermined input item.
